(19) United States
(12) Patent Application Publication
(10) Pub. No.: US 2026/0293789 A1
(43) Pub. Date: Oct. 1, 2026

(54) ADJUSTABLE TWIN-ROW ASSEMBLIES AND AGRICULTURAL IMPLEMENTS HAVING SUCH TWIN-ROW ASSEMBLIES

(71) Applicant: AGCO CORPORATION, Duluth, GA (US)

(72) Inventors: Benjamin Anson FANSHIER, Marion, KS (US); Robert L. FIGGER, Hesston, KS (US); Jarret Lee BRINKER, Beloit, KS (US)

(21) Appl. No.: 19/480,676

(22) PCT Filed: Apr. 25, 2024
(86) PCT No.: PCT/IB2024/054054

§ 371 Date: Oct. 31, 2025

Related U.S. Application Data
(60) Provisional application No. 63/500,538, filed on May 5, 2023.

(51) Int. Cl. A01B 63/24; A01C 7/04

(52) U.S. Cl. CPC A01B 63/24; A01C 7/04

(57) ABSTRACT

A twin-row assembly (134) of an agricultural implement (116) is disclosed. The twin-row assembly includes two row units (138) and a pivot system (166). The two row units rigidly connected to one another. Each row unit includes a row unit frame (176) and a gauge wheel (140) rotationally coupled to the row unit frame. The pivot system coupled to the two row units and configured to facilitate tandem rotation of the two row units relative to a toolbar (132) of the agricultural implement in a plane transverse to a forward direction. The forward direction being an intended direction of travel of the agricultural implement while being pulled by a tractor.

### CROSS-REFERENCE TO RELATED APPLICATION

This application claims the benefit of the filing date of U.S. Provisional Patent Application 63/500,538, “Adjustable Twin-Row Assemblies and Agricultural Implements Having Such Twin-Row Assemblies,” filed May 5, 2023, the entire disclosure of which is incorporated herein by reference.

### FIELD

Embodiments of the present disclosure relate generally to planting implements and other agricultural equipment, and more specifically to agricultural implement assemblies having adjustable twin-row assemblies, and to related methods.

### BACKGROUND

Agricultural machines, such as planting implements with a plurality of row units, are used to plant seeds in the ground. Planting implements may have a toolbar pulled by a tractor. The toolbar may include a central portion and wings extending from either side of the central portion. Individual row units may be mounted to the toolbar and configured to deliver seeds into separate rows as the planting implement is pulled by the tractor. To increase the speed with which fields can be planted, planting implements are becoming wider and the number of row units is increasing. Further, to increase the productivity of a farm, farmers attempt to reduce the spacing between neighboring rows of crops to increase the density of the crops.

During a growing season, a farmer may plant more than one type of crop. Different crops may be planted with different spacing between rows (which may be referred to in the art as “row spacing” or “row width”). As famers change from one crop to another with a different row spacing, row units are physically moved along the toolbar of the planting implement. Row units may be removed entirely from the planting implement for wider spacing, or additional row units may be added to the planting implement for narrower spacing. As the demand to increase productivity grows, many farmers attempt to narrow the row spacing of the crops. Narrowing the row spacing requires additional row units for a given area of the field. The attachments and systems equipped on individual row units are expensive and require significant space, resulting in significant costs for planting implements that have crowded arrangements of the equipment thereon.

### BRIEF SUMMARY

In an aspect of the disclosure a twin-row assembly of an agricultural implement assembly includes two row units and a pivot system. The two row units rigidly connected to one another. Each row unit includes a row unit frame and a gauge wheel rotationally coupled to the row unit frame. The pivot system is coupled to the two row units and configured to facilitate tandem rotation of the two row units relative to a toolbar of the agricultural implement in a plane transverse to a forward direction. The forward direction is an intended direction of travel of the agricultural implement while being pulled by a tractor. With two row units rigidly connected together, the two row units can be connected to an implement (e.g., including a toolbar) of the agricultural implement assembly with a single assembly, such as a single linkage system, which may reduce the number of components, complexity, and cost of the agricultural implement assembly. The tandem rotation of the two row units enabled by the pivot system may facilitate maintaining ground engagement for each of the two row units while the agricultural implement assembly traverses a side hill elevation, while also substantially maintaining the lateral distance between the two row units.

In some aspects, the pivot system is configured to facilitate rotation of the two row units responsive to an elevation difference of a ground surface contacted by the gauge wheels of each of the two row units.

In additional aspects, the twin-row assembly further includes a connection plate rigidly connected to each of the two row units, the connection plate defining a fixed distance between the two row units. In some aspects, the pivot system includes a pivot arm rigidly connected to the connection plate, and a pivot connected to the pivot arm and configured to facilitate the tandem rotation of the two row units. In some embodiments, the twin-row assembly further includes a linkage system connected to a toolbar of the agricultural implement and to the pivot system, and a pivot link extending from the pivot and rigidly connected to the linkage system, the pivot being positioned closer to a ground surface than a connection between the pivot link and the linkage system.

In some aspects, wherein the connection plate defines multiple openings configured for securing each of the two row units to the connection plate, the multiple openings defining multiple mounting positions for each of the two row units to the connection plate, wherein the two row units are spaced a different distance from one another for each of the mounting positions. Due to the connection plate that allows for connecting the two row units at varying distances, each twin-row assembly may be adjusted to be rigidly connected at an optimal distance from one another based on the crop being planted, managed, or harvested.

In various embodiments, the twin-row assembly further includes a linkage system connecting a toolbar of the agricultural implement to the pivot system, the linkage system configured to facilitate vertical movement of the two row units relative to the agricultural implement. In some aspects, the linkage system includes a planar linkage and includes a toolbar link, a vertical link, an upper link, and a lower link. The toolbar link is configured to rigidly couple to the toolbar. The vertical link is offset from the toolbar link. The upper link is pivotally connected to the toolbar link and the vertical link. The lower link is pivotally connected to the toolbar link and the vertical link. In some embodiments, the linkage system is a parallel linkage. The upper link and the lower link are oriented substantially parallel to one another independent of a rotational orientation of the upper link and the lower link relative to the toolbar link and the vertical link. In some aspects, the vertical link includes a connecting portion configured to rigidly connect to a pivot link of the pivot system. The pivot link spaces a pivot of the pivot system from the vertical link. In some aspects, the linkage system further includes a downforce system configured to substantially evenly apply a downforce to each of the two row units. As noted above, a single linkage system can connect the two row units to the implement, which may reduce the number of components, complexity, and cost of the agricultural implement assembly.

In another aspect of the disclosure there is provided an agricultural implement. The agricultural implement includes a toolbar and a twin-row assembly coupled to the toolbar. The twin-row assembly includes two row units and a connection plate. Each row unit includes a row unit frame and a gauge wheel rotationally coupled to the row unit frame. The connection plate is rigidly connected to the row unit frame of each of the two row units and defines a distance between the two row units. The connection plate defines multiple mounting configurations for at least one of the two row units for modifying the distance between the two row units. Since the connection plate allows for connecting the two row units at varying distances, each twin-row assembly may be adjusted to be rigidly connected at an optimal distance apart for whichever crop is being planted, managed, or harvested.

In some aspects, the connection plate defines multiple openings defining the multiple mounting configurations and configured for securing each of the two row units to the connection plate. Each mounting configuration defines a respective fixed distance between the two row units. In some embodiments, the multiple openings are arranged to define the multiple mounting configurations with fixed distances between the two row units to be within a range of from about 17.8 cm (about 7.0 inches) to about 38.1 cm (about 15.0 inches). In some embodiments, the multiple openings comprise mounting holes arranged in a row and at least one mounting slot offset and parallel to the row of mounting holes. The use of at least one mounting slot may simplify and improve assembly of the two row units to the connection plate as exact alignment within a slot is not necessary. The use of the mounting slot may also reduce tolerance requirements relative to the location of the mounting holes.

In some aspects, the twin-row assembly further includes a linkage system fixedly coupled to the toolbar. The linkage system includes parallel links configured to facilitate vertical movement of the two row units relative to the toolbar.

In some aspects, the twin-row assembly further includes a pivot system configured to facilitate tandem rotation of the two row units relative to the toolbar to change a vertical distance between the two row units. The tandem rotation of the two row units enabled by the pivot system may facilitate maintaining ground engagement for both of the two row units while the agricultural implement assembly traverses a side hill elevation, while substantially maintaining the lateral distance between the two row units.

In a further aspect of the disclosure there is provided an agricultural implement. The agricultural implement includes a frame, a toolbar carried by the frame, and a twin-row assembly. The twin-row assembly includes two row units, a connection plate, a linkage system, and a pivot system. The connection plate is rigidly connected to each of the two row units and defines a distance between the two row units. The linkage system is coupled to the toolbar. The linkage system is configured to facilitate simultaneous vertical movement of the two row units. The pivot system is coupled to the connection plate and is configured to facilitate tandem rotation of the two row units relative to the toolbar in a plane transverse to a forward direction in which the agricultural implement is configured to travel when pulled by a tractor. The two row units can be connected to an implement of the agricultural implement assembly with a single assembly, which may reduce the number of components, complexity, and cost of the agricultural implement assembly. The tandem rotation of the two row units enabled by the pivot system may facilitate maintaining ground engagement for both of the two row units while the agricultural implement assembly traverses a side hill elevation, while substantially maintaining the lateral distance between the two row units.

In further aspects, the pivot system includes a pivot, a pivot arm, and a pivot link. The pivot is configured to facilitate the tandem rotation of the two row units. The pivot arm is pivotally connected to the pivot and rigidly connected to the connection plate. The pivot link extends from the pivot and rigidly connected to the linkage system. The pivot is closer to an axis of the gauge wheel of each of the two row units than to either of the connection plate and a connection between the pivot link and the linkage system.

In additional embodiments, the connection plate includes multiple openings formed therethrough. The multiple openings are configured for attaching each of the two row units to the connection plate. The multiple openings arranged to provide multiple mounting positions for each of the two row units to the connection plate defining a respective fixed distance between the two row units.

Within the scope of this application it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified top view of a tractor pulling an agricultural implement;

FIG. 2 is a perspective view of a twin-row assembly of the agricultural implement of FIG. 1;

FIG. 3 is another perspective view of the twin-row assembly of FIG. 2;

FIG. 4 is a front view of the twin-row assembly of FIG. 2;

FIG. 5 is a side view of the twin-row assembly of FIG. 2;

FIG. 6 is a side view of the twin-row assembly of FIG. 5 on a hill; and

FIG. 7 is a front view of the twin-row assembly of FIG. 2 on a side hill having a change in elevation in a lateral direction.

### DETAILED DESCRIPTION

The illustrations presented herein are not actual views of any agricultural machine or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure, assembly, or sprayer. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

As used throughout, ranges are used as shorthand for describing each and every value that is within the range. Any value within the range can be selected as the terminus of the range.

From reading the following description it should be understood that the terms “longitudinal” and “transverse” are made in relation to a machine's (e.g., agricultural implement's, agricultural application machine's) normal direction of travel. In other words, the term “longitudinal” equates to the fore-and-aft direction, whereas the term “transverse” equates to the crosswise direction, or left and right. As used herein, the terms “lateral” and “transverse” are used interchangeably. Furthermore, the terms “axial” and “radial” are made in relation to a rotating body such as a shaft, wherein axial relates to a direction along the rotation axis and radial equates to a direction perpendicular to the rotation axis. In addition, a “vertical direction” means and includes a direction that is substantially perpendicular to the longitudinal direction and the transverse direction (e.g., in the direction of gravity).

In various embodiments, the present disclosure relates to twin-row assemblies for an agricultural implement. The agricultural implement includes a frame including a tow hitch configured to be towed by a tractor, a toolbar coupled to the frame, and one or more twin-row assemblies coupled to the toolbar. The twin-row assemblies each individually includes a two row units, a linkage system configured to fixedly couple the two row units to the toolbar, and a pivot system coupled to the linkage system and the two row units and configured to facilitate vertical movement of the two row units of the twin-row assembly. The two row units of each twin-row assembly may be configured to move in tandem as the agricultural implement is moved in a forward direction by the tractor. In some embodiments, the pivot system is coupled to the two row units by a connection plate that connects the two row units together.

Each of the two row units may be fixedly coupled to the connection plate configured for rigidly connecting the two row units to the pivot system. Each row unit may be connected to the connection plate at one of multiple locations to fixedly connect the two row units to one another at a fixed distance. The fixed distance between the row units may be varied by altering the location(s) at which the row unit(s) couple to the connection plate to facilitate different row spacing. Accordingly, the connection plate facilitates optimizing the row spacing between the row units of the row assembly based on the crops being planted or worked while maintaining a fixed distance between the row units of the row assembly. Further, with two row units of a row assembly rigidly connected together, the two row units can be connected to the toolbar with a single assembly (such as a combination of the pivot system and the linkage system), which may reduce the number of components, complexity, and cost of the agricultural implement assembly relative to conventional twin row units.

The pivot system may be configured to facilitate tandem rotation of the two row units relative to the other components of the agricultural implement (e.g., the frame and the toolbar) in a plane transverse to a forward direction (e.g., about a longitudinal axis of the forward direction), the tandem rotation of the two row units changing a vertical spacing between the two row units relative to the ground surface and relative to one another. The tandem rotation of the two row units may facilitate maintaining engagement between each of the two row units and the ground surface while the agricultural implement traverses a side hill elevation (a difference in elevation between the two row units), while substantially maintaining the lateral distance between the two row units.

The linkage system may be configured to facilitate simultaneous vertical movement of the two row units while maintaining contact between the ground surface and each of each of the two row units. In some embodiments, the linkage system facilitates substantially the same vertical movement of the two row units relative to the other components of the implement (e.g., the frame and the toolbar). For example, the linkage system may maintain ground contact of each of the two row units while the agricultural implement traverses hills and bumps (particularly while the wheels of the tractor are at a different vertical elevation than the two row units (e.g., gauge units of the two row units)) using significantly fewer components (such as half the components) than a conventional agricultural implement.

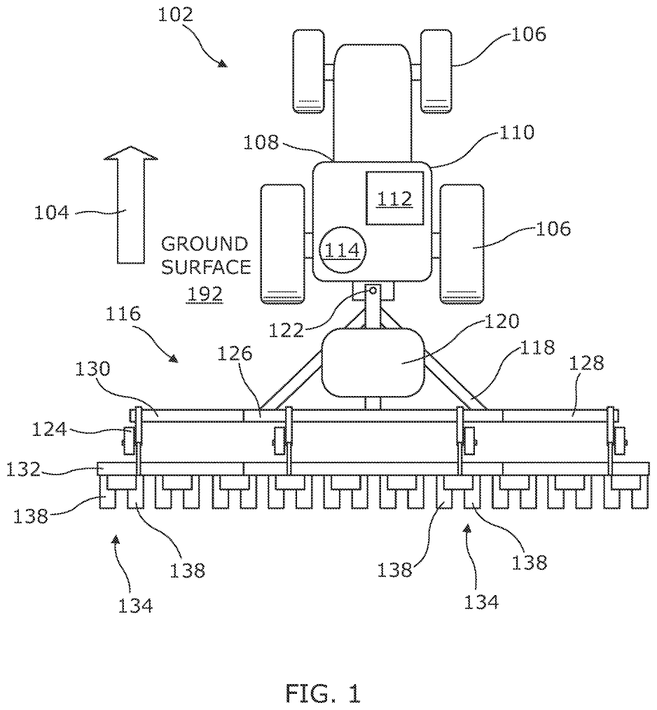

FIG. 1 illustrates a tractor 102 drawing an agricultural implement 116 (also referred to as an “implement”) in a forward direction 104, the forward direction 104 being an intended direction of travel of the agricultural implement 116 while being pulled by the tractor 102. The tractor 102 includes wheels 106, an engine, and a chassis 108 supported by the wheels 106 that contact a ground surface 192. The agricultural implement 116 includes a frame 118 carrying a toolbar 132 and twin-row assemblies 134 connected to the toolbar 132. The twin-row assemblies 134 may be attached to the toolbar 132 and carried by the toolbar 132.

Each of the twin-row assemblies 134 individually includes two row units 138. Each of the two row units 138 of each of the twin-row assemblies 134 may be connected to a central hopper 120 containing seed to be planted and/or fertilizer to be applied. That is, the two row units 138 may be planter and/or fertilizer row units. The agricultural implement 116, and in particular, the frame 118, is connected to the tractor 102 by a tow hitch 122. A computer 112, which may include a central processing unit (“CPU”), memory, implement controller, and graphical user interface (“GUI”) (e.g., a touch-screen interface), is typically located in an operator cabin 110 of the tractor 102. A global positioning system GPS receiver 114 may be mounted to the tractor 102 and connected to communicate with the computer 112. The implement controller of the computer 112 is configured to communicate with one or more of the twin-row assemblies 134, the two row units 138, and/or the GPS receiver 114, such as by wired or wireless communication.

The agricultural implement 116 may optionally be supported in the field by at least one wheel 124 coupled to the frame 118. In other embodiments, the wheels 124 of the agricultural implement 116 may be omitted, and the height of the toolbar 132 may be controlled by the tow hitch 122, as shown in U.S. Patent Application Publication 2021/0315147, “Systems comprising agricultural implements connected to lifting hitches and related control systems and methods,” published Oct. 14, 2021. The frame 120 may include a center section 126 configured to be towed by the tractor 102, and one or more wing sections 128, 130 hingedly coupled to the center section 126. For example, and as shown in FIG. 1, the center section 126 may be a center section, and two wing sections 128, 130 may be attached to opposite lateral sides thereof. The wing sections 128, 130 may fold for transport or storage, and unfold (as shown in FIG. 1) for planting, fertilizing, or other field operations. The wheels 124, if present, may support any or all of the wing sections 128, 130. In other embodiments, the center section 126 may be omitted, and two wing sections 128, 130 may be connected directly to one another, as shown, for example, in U.S. Patent Application Publication 2021/0315147.

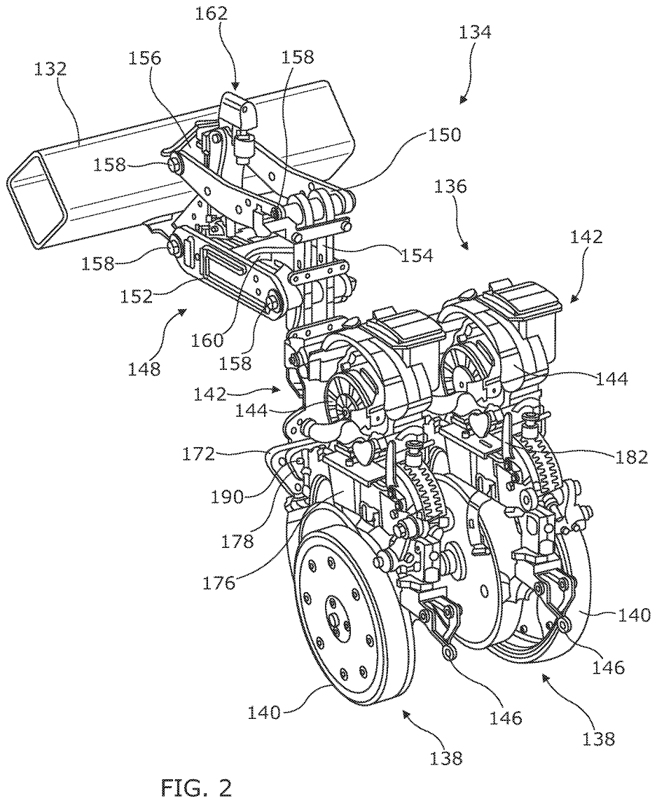

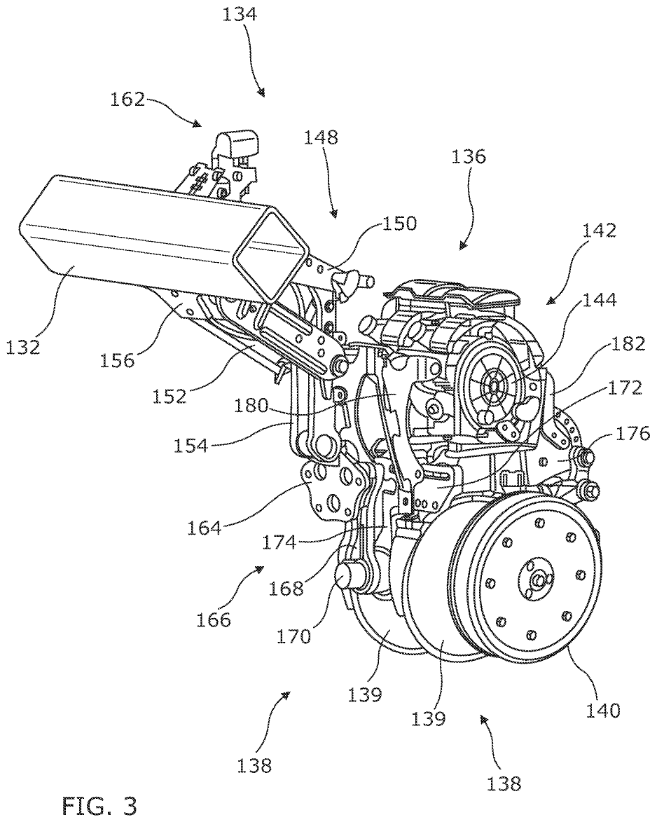

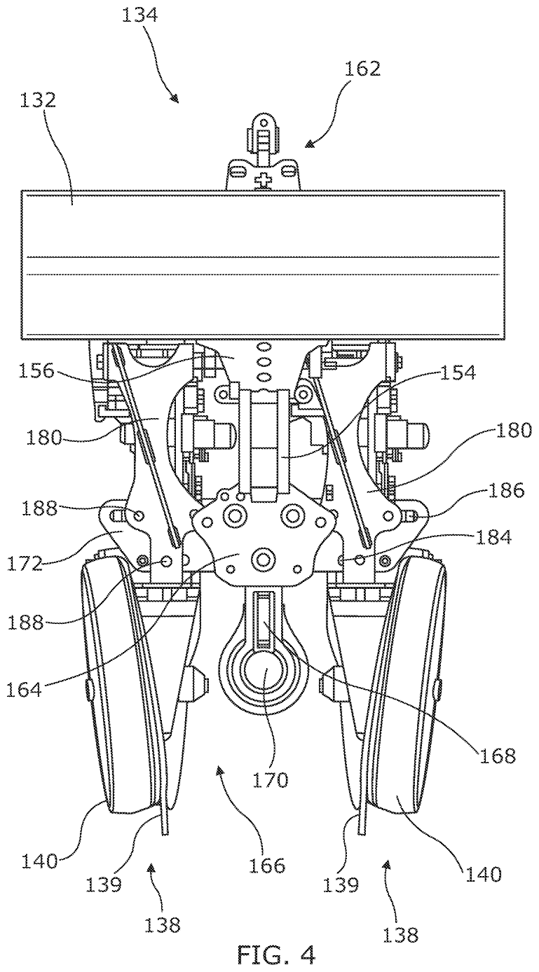

FIG. 2 is a perspective view of embodiments of a twin-row assembly 134 of the agricultural implement 116 of FIG. 1. FIG. 3 is another perspective view of embodiments of the twin-row assembly 134 of FIG. 2. FIG. 4 is a front view of embodiments of the twin-row assembly 134 of FIG. 2. Referring to FIGS. 2-4, the twin-row assembly 134 includes two row units 138 and one or both of a linkage system 148 and a pivot system 166. The twin-row assembly 134 may be coupled to the toolbar 132 by the linkage system 148. The two row units 138 are rigidly connected together. In some embodiments, the twin-row assembly 134 includes a connection plate 172 to which each of the row units 138 are rigidly connected to fix a distance (e.g., a lateral distance) between the two row units 138. Each row unit 138 includes a row unit frame 176, a metering system 142, an opening wheel 139, and a gauge wheel 140. In some embodiments, the row unit frame 176 includes a connector 146 configured for connecting attachments (e.g., closing wheels) to the respective row unit 138.

The metering system 142 is mounted to the row unit frame 176 and includes a meter 144 configured to control distribution of a product, such as seed or fertilizer. In some embodiments, the meter 144 comprises a vacuum meter. In the embodiments illustrated in FIGS. 2-4, the metering system 142 is mounted to the row unit frame 176 via a front support 180 extending from a front of the metering system 142 to a front of the row unit frame 176 and a rear support 182 extending from a rear of the metering system 142 to a rear of the row unit frame 176, the front positioned in the forward direction 104 (FIG. 1) and closer to the toolbar 132 (e.g., the fore direction) relative to the rear when the twin-row assembly 134 is connected to agricultural implement 116 (e.g., the toolbar 132).

The opening wheel 139 and gauge wheel 140 are rotationally coupled to the row unit frame 176. During use and operation of the agricultural implement 116, the opening wheels 139 and gauges wheels 140 may be configured to engage the ground 192 and may be positioned vertically below the metering systems 142 (e.g., closer to the ground 192 than the metering systems 142).

The connection plate 172 of the row assembly 136 is configured to connect the two row units 138 of the twin-row assembly 134 together. Each of the row units 138 of a twin-row assembly 134 may be fixedly attached to the connection plate 172 to connect the two row units 138 at a fixed distance between the two row units 138. In some embodiments, the connection plate 172 is an adjustment plate configured for connecting the two row units 138 at different fixed distances for different field operations (e.g., planting operations, fertilizing operations) for which different row spacing may be desired.

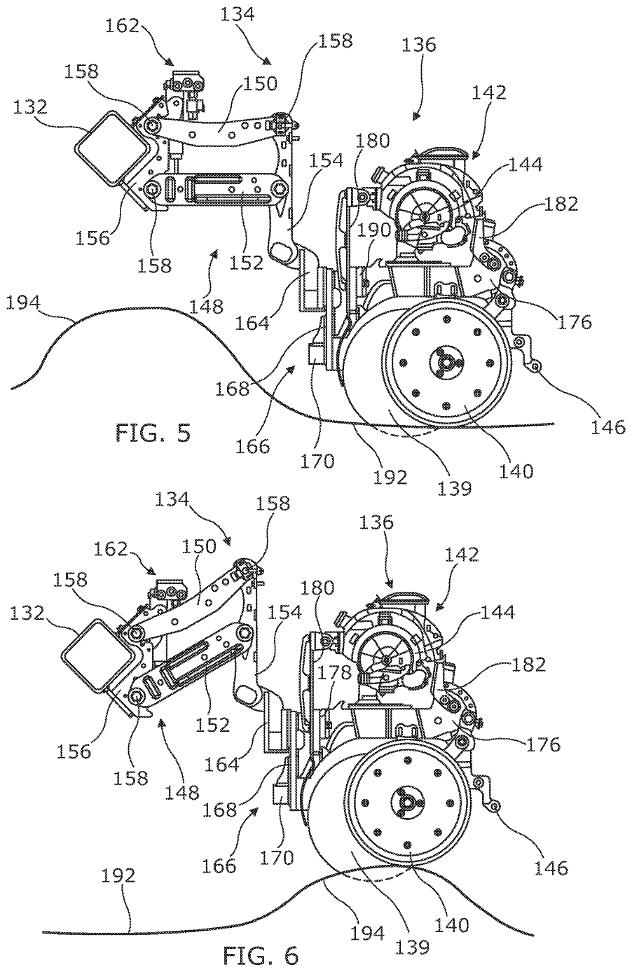

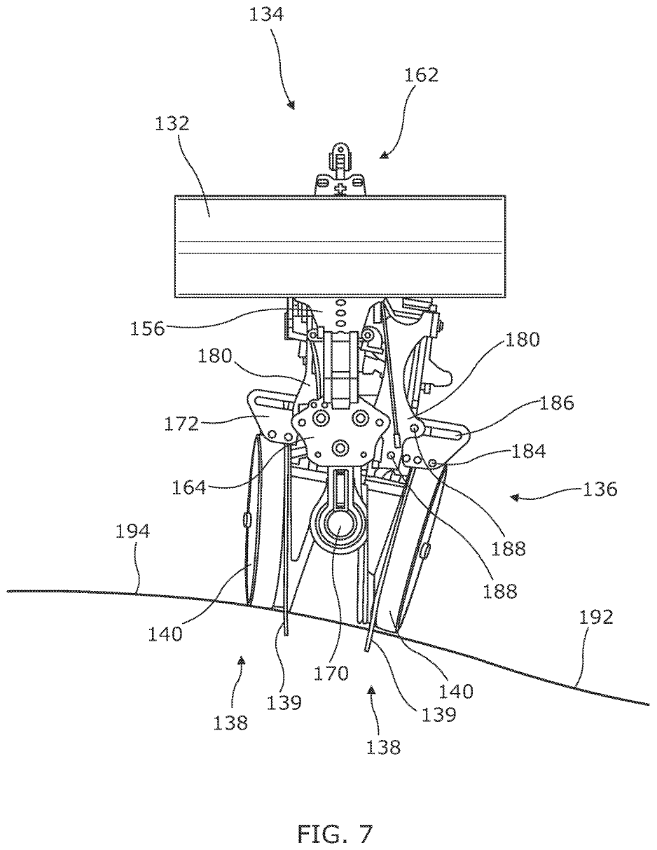

The connection plate 172 may include multiple openings formed therein and is configured for securing each row unit 138 thereto. The openings (e.g., apertures) may include features chosen from one or both of mounting holes 184 and mounting slots 186. As can be seen in FIG. 3, FIG. 4, and FIG. 7, in some embodiments, the mounting holes 184 are arranged in a row and at least one mounting slot 186 is offset (e.g., vertically offset) and parallel to the row of mounting holes 184. In some embodiments, the connection plate 172 includes parallel mounting slots 186 and mounting holes 184 formed therein that laterally neighbor one of the mounting slots 186. The multiple openings may be configured to receive fasteners therein. In some embodiments, the connection plate 172 is coupled to the row unit frame 176 with fasteners extending through openings 190 (FIG. 2, FIG. 5) within a surface 178 (FIG. 2, FIG. 6) of the row unit frame 176. The connection plate 172 may further be coupled to the front supports 180, such as via the fasteners extending through openings 188 (FIG. 4) in the front supports 180.

In some embodiments, the mounting holes 184 and mounting slots 186 laterally extend across the connection plate 172 and are arranged to provide multiple mounting positions for each of the row units 138 and to facilitate altering a position of each of the row units 138 relative to one another. In some embodiments, the connection plate 172 is configured to rigidly connect the two row units 138 of a row assembly 136 while facilitating multiple mounting configurations of the row units 138, each mounting configuration including a different spacing between the row units 138 to define the fixed distance between the two row units 138. For example, each mounting configuration defines a fixed distance between the two row units 138, which is different than the fixed distance between the two row units 138 connected to the connection plate 172 in a different mounting configuration.

The mounting holes 184 and the mounting slots 186 may be arranged on the connection plate 172 such that the fixed distance between the row units 138 may be adjusted incrementally to facilitate various fixed distances between the row units 138 on the connection plate 172 between a minimum distance and a maximum distance. The fixed distance between the two row units 138 may be adjusted, such as within a range of from about 17.8 cm (about 7.0 inches) to about 38.1 cm (about 15.0 inches). By way of non-limiting example, the connection plate 172 may be configured such that the fixed distance between the two row units 138 may be changed to any of about 17.8 cm (about 7.0 inches), about 22.9 cm (about 9.0 inches), about 30.5 cm (about 12.0 cm), or about 38.1 cm (about 15.0 inches), depending on the desired operation of the twin-row assembly 134. However, the disclosure is not so limited, and the fixed distance between the two row units 138 defined by various mounting configurations may be different than those described.

The linkage system 148 may be configured to connect the twin-row assembly 134 to the agricultural implement 116 (e.g., to the toolbar 132). As will be described in greater detail below, the linkage system 148 is configured for controlling vertical movement of the two row units 138 together relative to the agricultural implement 116 (e.g., the toolbar 132).

In some embodiments, the linkage system 148 is a planar linkage (e.g., a four-bar linkage) and includes a toolbar link 156, a vertical link 154, an upper link 150, and a lower link 152. The toolbar link 156 may be rigidly coupled to the toolbar 132. The toolbar link 156 may exhibit a ‘V’ or a ‘C’ shape and may be configured to attach to different sides of the toolbar 132, such as at substantially perpendicular surfaces of the toolbar 132.

The upper link 150 and the lower link 152 may be vertically spaced from one another by the toolbar link 156 and the vertical link 154. The upper link 150 and the lower link 152 each pivotally connect to the toolbar link 156 and to the vertical link 154 at joints 158. The upper link 150 and the lower link 152 may be configured to rotate about the joints 158 and with respect to each of the vertical link 154, the toolbar link 156, and the toolbar 132. The upper link 150 may be pivotably connected to the toolbar link 156 at or adjacent to a first end of the toolbar link 156 at a joint 158. In addition, the upper link 150 may be pivotably connected to the vertical link 154 at or adjacent a first end of the vertical link 154 at a joint 158. The lower link 152 may be pivotably connected to the toolbar link 156 at or adjacent a second end of the toolbar link 156 at a joint 158. In addition, the lower link 152 may be pivotably connected to the vertical link 154 at or adjacent a second end of the vertical link 154 at a joint 158. The joints 158 may include fasteners, such as bolts (e.g., pivot bolts).

In some embodiments, the linkage system 148 is a parallel linkage with the upper link 150 and the lower link 152 remaining substantially parallel independent of the rotational orientation of the upper link 150 and the lower link 152 relative to the toolbar link 156 and the vertical link 154 (e.g., relative to the direction substantially perpendicular to the ground 192). In some embodiments, the parallel linkage is configured to maintain the vertical link 154 in a substantially vertical orientation. The vertical link 154 may be configured to remain substantially stationary with respect to the two row units 138 and the pivot system 166. In some embodiments, the upper link 150 includes two links extending parallel to one another, each individually connected to the toolbar link 156 and the vertical link 154 at the same joint 158; and the lower link 152 includes two links extending parallel to one another, each individually connected to the toolbar link 156 and the vertical link 154 at the same joint 158.

In some embodiments, the vertical link 154 is laterally offset from the toolbar link 156 and is configured to extend substantially vertically while the linkage system 148 is coupled to the toolbar 132 and the agricultural implement 116 is connected to the tractor 102. A second end of the vertical link 154 is configured to connect the row assembly 136 row units 138 to the linkage system 148, directly or indirectly, such as via the pivot system 166. In some embodiments, the vertical link 154 includes a connecting portion 164 configured for fastening the linkage system 148 to the pivot system 166. In the embodiments illustrated in FIGS. 2-4, the vertical link 154 includes two links extending parallel to one another, each link rigidly connected to the connecting portion 164 at or adjacent to the second end of the vertical link 154.

In some embodiments, the linkage system 148 includes a downforce system 162 configured to apply a downward force (e.g., in the vertical direction towards the ground 192) to the row assembly 136 to maintain engagement of the row units 138 with the ground 192. In some embodiments, the downforce system 162 is mounted on the toolbar link 156 and is configured to engage and apply the downward force to one or more of the lower link 152, the upper link 150, and the vertical link 154, which downward force is translated through the linkage system 148 to the row units 138 of the row assembly 136. The downforce system 162 may include one or more force applicators chosen from a hydraulic cylinder, a spring, and the like. In some embodiments, the twin-row assembly 134 is configured such that the downward force applied by the downforce system 162 is substantially evenly distributed between the two row units 138.

FIG. 5 is a side view of embodiments of the twin-row assembly 134 of FIG. 2 as the twin-row assembly 134 approaches a hill 194. FIG. 6 is a side view of the embodiments of the twin-row assembly 134 of FIG. 5 on the hill 194. During planting, fertilizing, or other field operations, the ground surface 192 may exhibit non-planar surfaces. When the tractor 102 and the agricultural implement 116 are on a substantially flat surface, the gauge wheels 140 (which control the position of the opening wheels 139) may engage the ground surface 192 at substantially the same vertical height as the wheels 106 of the tractor 102. However, as the tractor 102 traverses over an uneven ground surface 192 (e.g., including hills 194, valleys, mounds, depressions in the ground surface 192), the gauge wheels 140 may engage the ground surface 192 at a different vertical height than the wheels 106, depending on the incline of the ground surface 192. As noted above, the linkage system 148 is configured to facilitate vertical movement of the two row units 138 relative to the agricultural implement 116 (e.g., the toolbar 132) as the agricultural implement 116 traverses over the ground surface 192. The linkage system 148 is configured to adjust (e.g., compensate) for a height difference between the agricultural implement 116 (e.g., the toolbar 132) and the two row units 138 due to the uneven ground surface 192 encountered by the agricultural implement 116. As can be seen in FIG. 5, while on a level portion of the ground surface 192, the linkage system 148 is generally in a first position, with each of the upper link 150 and the lower link 152 in a first rotational orientation with respect to each of the vertical link 154 and the toolbar link 156 (e.g., the longitudinal axes of the upper link 150 and the lower link 152 are substantially parallel with respect to the ground 192 and substantially perpendicular with respect to the longitudinal axis of the vertical link 154). While the first rotational orientation of the upper link 150 and the lower link 152 is illustrated as being parallel to the ground surface 192 in FIG. 5, other orientations of the upper link 150 and the lower link 152 are also contemplated.

In response to traversing over the uneven ground surface 192, where the gauge wheels 140 of the two row units 138 engage the ground surface 192 at a different elevation than the wheels 106 of the tractor 102, the upper link 150 and the lower link 152 may rotate (e.g., in a plane parallel to the forward direction 104) relative to both the toolbar link 156 and the vertical link 154 to a rotational orientation different than that of the first rotational orientation. For example, the upper link 150 and the lower link 152 may rotate about a longitudinal axis of the vertical link 154 (e.g., in the direction substantially perpendicular to the ground 192; in the vertical direction). In some embodiments, each of the upper link 150 and the lower link 152 may independently and individually rotate with respect to each of the toolbar link 156 and the vertical link 154 at the relative joints 158. Rotation of the upper link 150 and the lower link 152 relative to the toolbar link 156 and the vertical link 154 may change the vertical distance between the agricultural implement 116 (e.g., the toolbar 132) and the row assembly 136 (e.g., the gauge wheels 140). In some embodiments, a vertical distance between the toolbar 132 and the row assembly 136 may be reduced responsive to the gauge wheels 140 engaging the ground surface 192 that is higher than the ground surface 192 engaged by the wheels 106; and the vertical distance between the toolbar 132 and the gauge wheels 140 may be increased responsive to the gauge wheel 140 engaging the ground surface 192 that is lower than the ground surface 192 engaged by the wheels 106. As can be seen in FIG. 6, the vertical link 154 and the row assembly 136 are configured to move vertically relative to the toolbar 132 and the toolbar link 156 since the toolbar link 156 is fixedly affixed to and configured to move with the toolbar 132 and the vertical link 154 is pivotably coupled to the toolbar link 156 via the joints 158 by means of the upper link 150 and the lower link 152. As can be seen in FIGS. 5 and 6, due to the rotation of the upper link 150 and the lower link 152 and the corresponding angle between the vertical link 154 and each of the upper link 150 and the lower link 152, the vertical link 154 may move towards or away from (e.g., laterally towards or away from) the toolbar 132 while moving vertically relative to the toolbar 132.

As noted above, the downforce system 162 is configured to maintain engagement of the two row units 138 with the ground surface 192. The downforce system 162 is also configured to allow upward movement of the vertical link 154 and the two row units 138 relative to toolbar 132 due to the increased elevation of the ground surface 192 engaged by the gauge wheels 140 relative to the ground surface 192 under the toolbar 132 and engaged by the wheels 106 of the tractor 102.

In various embodiments, the linkage system 148 is a parallel linkage configured to maintain the vertical link 154 in a substantially vertical orientation. The single linkage system 148 shared by the two row units 138 may facilitate each row unit 138 following changes in the terrain of the ground surface 192 as if the two row units 138 were single row units and directly attached to the toolbar 132. Each row unit 138 may be laterally spaced from neighboring row units 138 a sufficient distance such that each row unit 138 may include a separate metering system 142, facilitating improved planting singulation (e.g., the meter 144 feeding one seed at a time) relative to conventional twin row units. Further, by guiding the vertical movement of the row assembly 136 with a single linkage system 148, multiple row units 138 (e.g., two row units 138) can be guided by and have ground engagement maintained by the single linkage system 148 and a single downforce system 162. Compared to conventional twin-row planters, the row assembly 136 described herein may include only one downforce system 162 for each pair of the row units 138 rather than a downforce system 162 for each of the row units 138.

FIG. 7 is a front view of embodiments of the twin-row assembly 134 of FIG. 2 on a hill 194 having a change in elevation in the lateral direction (e.g., the direction between the row units 138) such that a gauge wheel 140 of a first row unit 138 of the twin-row assembly 134 engages the ground surface 192 at a different vertical height than a second row unit 138 of the twin-row assembly 134. Referring to FIGS. 2-4 and 7, the pivot system 166 is configured to facilitate rotation of the two row units 138 relative to the frame 118, the toolbar 132, and the linkage system 148 in a plane transverse to the forward direction 104 and the vertical direction (e.g., in the lateral direction between the row units 138; in the left and right direction in the view of FIG. 7; in a plane intersecting an axis of rotation of the gauge wheels 140). The rotation of the two row units 138 may be about the forward direction. The rotation of the two row units 138 includes tandem rotation of the two row units 138 (e.g., the two row units 138 rotating together and by the substantially the same amount), while maintaining the spatial relationships therebetween, and in particular, the fixed distance between the two row units 138. In some embodiments, the angle between the axis of rotation of each gauge wheel 140 and the ground surface 192 engaged by the gauge wheel may be about the same after rotation of the two row units 138. Rotation of the two row units 138 with the pivot system 166 may adjust the relative height of the gauge wheels 140 with respect the ground surface 192 and with respect to one another. In various embodiments, the pivot system 166 is configured to guide rotation of the two row units 138 responsive to an elevation difference between each of the gauge wheels 140 and the ground surface 192.

As shown in FIG. 3, the pivot system 166 may include a pivot 170, a pivot link 168, and a pivot arm 174. The pivot 170 is configured to facilitate rotation of the row assembly 136 relative to the toolbar 132 responsive to the side elevation differences of the ground surface 192 on the side hill 194. The pivot 170 may pivotally connect the pivot arm 174 to the pivot link 168. In some embodiments, the pivot arm 174 vertically extends from the connection plate 172 of the row assembly 136 to the pivot system 166 and is configured to connect the pivot system 166 to the row assembly 136. The pivot arm 174 may extend laterally between the two row units 138 that are coupled to the connection plate 172.

The pivot link 168 extends between and attaches to the vertical link 154 and the pivot 170. The pivot link 168 is configured to couple to the vertical link 154 and is oriented such that the pivot 170 is below the connection between the vertical link 154 and the pivot link 168 (i.e., the pivot 170 is closer to the ground 192 and the gauge wheels 140 than the vertical link 154). In some embodiments, the pivot link 168 is configured to couple to the connecting portion 164 of the vertical link 154 and to position the pivot 170 lower than the connecting portion 164.

In some embodiments, the pivot arm 174 extends from the pivot 170 to the connection plate 172 to connect the pivot 170 to the connection plate 172 and may be configured to position the pivot 170 below the connection plate 172 and the row unit frame 176 of each of the two row units 138 (i.e., closer to the ground 192 than the connection plate and each row unit frame 176). In some embodiments, the pivot 170 is positioned in a vertical direction closer to an axis of rotation of the gauge wheels 140 than to each of the connection plate 172, the row unit frame 176 of each of the two row units 138, and the connection between the pivot link 168 and the linkage system 148 (e.g., the connecting portion 164).

The pivot arm 174 may be rigidly connected to the connection plate 172. In some embodiments, the pivot arm 174 and the connection plate 172 comprise a unitary body. In other embodiments, the pivot arm 174 is independent of the connection plate 172 and may be fixedly attached thereto, such as with fasteners.

The pivot arm 174 is configured to connect the two row units 138 to the pivot system 166 and is pivotally connected to the pivot link 168 via the pivot 170, which allows the pivot arm 174 (and the connection plate 172 and the attached row units 138) to rotate relative to the pivot link 168 and the linkage system 148 in the lateral direction in the plane transverse to the forward direction 104. The rotation of the pivot arm 174 relative to the pivot link 168 facilitates rotation of the two row units 138 with respect to the linkage system 148 and the agricultural implement 116. In addition, the rotation of the row assembly 136 with respect to the agricultural implement 116 adjusts the vertical height of the gauge wheels 140 of each of the two row units 138 relative to one another.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A twin-row assembly for an agricultural implement, the twin-row assembly comprising:
two row units rigidly connected to one another, each row unit including a row unit frame, a metering system carried by the row unit frame, an opening wheel rotationally coupled to the row unit frame, and a gauge wheel rotationally coupled to the row unit frame; and
a pivot system coupled to the two row units and configured to facilitate tandem rotation of the two row units relative to a toolbar of the agricultural implement in a plane transverse to a forward direction, the forward direction being an intended direction of travel of the agricultural implement while being pulled by a tractor.

2. The twin-row assembly of claim 1, wherein the pivot system is configured to facilitate rotation of the two row units responsive to an elevation difference of a ground surface contacted by the gauge wheels of each of the two row units.

3. The twin-row assembly of claim 1, further comprising a connection plate rigidly connected to each of the two row units, the connection plate defining a fixed distance between the two row units.

4. The twin-row assembly of claim 3, wherein the pivot system comprises:
a pivot arm rigidly connected to the connection plate; and
a pivot connected to the pivot arm and configured to facilitate the tandem rotation of the two row units.

5. The twin-row assembly of claim 4, further comprising:
a linkage system connected to a toolbar of the agricultural implement and to the pivot system; and
a pivot link extending from the pivot and rigidly connected to the linkage system, the pivot being positioned closer to a ground surface than a connection between the pivot link and the linkage system.

6. The twin-row assembly of claim 3, wherein the connection plate defines multiple openings configured for securing each of the two row units to the connection plate, the multiple openings defining multiple mounting positions for each of the two row units to the connection plate, wherein the two row units are spaced a different distance from one another for each of the mounting positions.

7. The twin-row assembly of claim 1, further comprising a linkage system connecting a toolbar of the agricultural implement to the pivot system, the linkage system configured to facilitate vertical movement of the two row units relative to the agricultural implement.

8. The twin-row assembly of claim 7, wherein the linkage system comprises a planar linkage and comprises:
a toolbar link configured to rigidly couple to the toolbar;
a vertical link offset from the toolbar link;
an upper link pivotally connected to the toolbar link and the vertical link; and
a lower link pivotally connected to the toolbar link and the vertical link.

9. The twin-row assembly of claim 8, wherein the linkage system is a parallel linkage, the upper link and the lower link oriented substantially parallel to one another independent of a rotational orientation of the upper link and the lower link relative to the toolbar link and the vertical link.

10. The twin-row assembly of claim 8, wherein the vertical link comprises a connecting portion configured to rigidly connect to a pivot link of the pivot system, the pivot link spacing a pivot of the pivot system from the vertical link.

11. The twin-row assembly of claim 8, wherein the linkage system further comprises a downforce system configured to substantially evenly apply a downforce to each of the two row units.

12. An agricultural implement, comprising:
a toolbar; and
a twin-row assembly coupled to the toolbar, the twin-row assembly comprising:
two row units, each row unit comprising a row unit frame, a metering system carried by the row unit frame, an opening wheel rotationally coupled to the row unit frame, and a gauge wheel rotationally coupled to the row unit frame; and
an adjustment plate rigidly connected to the row unit frame of each of the two row units and defining a distance between the two row units, the adjustment plate defining multiple mounting configurations for at least one of the two row units for modifying the distance between the two row units.

13. The agricultural implement of claim 12, wherein the adjustment plate defines multiple openings defining the multiple mounting configurations and configured for securing each of the two row units to the adjustment plate, each mounting configuration defining a respective fixed distance between the two row units.

14. The agricultural implement of claim 13, wherein the multiple openings are arranged to define the multiple mounting configurations with fixed distances between the two row units to be within a range of from about 17.8 cm (about 7.0 inches) to about 38.1 cm (about 15.0 inches).

15. The agricultural implement of claim 13, or wherein the multiple openings comprise mounting holes arranged in a row and at least one mounting slot offset and parallel to the row of mounting holes.

16. The agricultural implement of claim 12, wherein, the twin-row assembly further comprises a linkage system fixedly coupled to the toolbar, the linkage system comprising parallel links configured to facilitate vertical movement of the two row units relative to the toolbar.

17. The agricultural implement of claim 12, wherein the twin-row assembly further comprises a pivot system configured to facilitate tandem rotation of the two row units relative to the toolbar to change a vertical distance between the two row units.

18. An agricultural implement, comprising:
a frame;
a toolbar carried by the frame; and
a twin-row assembly comprising:
two row units, each row unit comprising a metering system, an opening wheel, and a gauge wheel;
a connection plate rigidly connected to each of the two row units and defining a distance between the two row units;
a linkage system coupled to the toolbar, the linkage system configured to facilitate simultaneous vertical movement of the two row units; and
a pivot system coupled to the connection plate and configured to facilitate tandem rotation of the two row units relative to the toolbar in a plane transverse to a forward direction in which the agricultural implement is configured to travel when pulled by a tractor.

19. The agricultural implement of claim 18, wherein the pivot system comprises:
a pivot configured to facilitate the tandem rotation of the two row units;
a pivot arm pivotally connected to the pivot and rigidly connected to the connection plate; and
a pivot link extending from the pivot and rigidly connected to the linkage system, the pivot closer to an axis of the gauge wheel of each of the two row units than to either of the connection plate and a connection between the pivot link and the linkage system.

20. The agricultural implement of claim 18, or wherein the connection plate comprises multiple openings formed therethrough, the multiple openings configured for attaching each of the two row units to the connection plate, the multiple openings arranged to provide multiple mounting positions for each of the two row units to the connection plate defining a respective fixed distance between the two row units.
